(19) United States
(12) Patent Application Publication
(10) Pub. No.: US 2022/0119677 A1
(43) Pub. Date: Apr. 21, 2022

(54) CURABLE SILICONE COMPOSITION WITH A GOOD FLAME RESISTANCE

(71) Applicant: ELKEM SILICONES SHANGHAI CO., LTD., Shanghai (CN)

(72) Inventors: Wenjuan ZHOU, Shanghai (CN); Suwen YE, Shanghai (CN); Zhiguang SUN, Shanghai (CN)

(21) Appl. No.: 17/426,849

(22) PCT Filed: Jan. 31, 2019
(86) PCT No.: PCT/CN2019/074155

§ 371 Date: Jul. 29, 2021

(51) Int. Cl. C09D 183/14; C08G 77/50; C08K 9/04; C08K 3/26; C08K 3/22; C08K 3/36; C09D 5/18; C09D 7/62; D06N 3/00; D06N 3/12

(52) U.S. Cl. CPC C09D 183/14; C08G 77/50; C08K 9/04; C08K 3/26; C08K 3/22; C08G 77/70; C09D 5/18; C09D 7/62; D06N 3/0059; D06N 3/0063; D06N 3/128; C08K 3/36

(57) ABSTRACT

The invention relates to a curable silicone composition comprising (A) a polyorganosiloxane polymer, (B) a cross-linking organosilicon compound having at least 2 silicon-bonded reactive groups, (C) a catalyst capable of promoting the reaction between component (A) and component (B); and (D) from 0.001 to 20%, preferably from 0.01 to 16%, more preferably from 0.05 to 12% of a bentonite, based on the total weight of the other components in the composition; wherein the bentonite is treated with a treatment agent containing at least a quaternary ammonium salt. Furthermore, it is also related to a method of improving the flame resistance of a curable silicone composition as well as a product obtained therefrom.

### TECHNICAL FIELD

The invention relates to a curable silicone composition with a good flame resistance, a method of improving the flame resistance of a curable silicone composition as well as a product obtained from the inventive curable silicone composition. Furthermore, it also relates to the use of a bentonite for improving the flame resistance of a curable silicone composition.

### BACKGROUND OF THE INVENTION

The liquid silicone rubber (LSR) is a curable silicone composition which has been already used widely as a coating composition in various applications such as in automotive industry, electronic devices, medical materials and so on.

As regards some important products such as airbags, the flame resistance is strictly required. In order to improve the flame resistance of silicone rubber composition, adding various inorganic filler and organopolysiloxane resin becomes normal way.

US2013099468 uses organophosphazene compound in the silicone rubber coating on an airbag base fabric to achieve low burning rate less than 50 mm/min according to the FMVSS-302 test, and the cured coating exhibits a low surface tack and a high anti-blocking property.

JP3165312 discloses a liquid silicone rubber coating composition for an airbag prepared with organopolysiloxane resin, the silicone rubber of the base fabric with a small amount of coating (17˜19 gsm) has excellent flame retardancy with burning speed less than 50 mm/min.

U.S. Pat. No. 5,529,837A discloses a silicone coating composition containing a carbon, NiO₂, FeO, FeO₂, Fe₂O₃, Fe₃O₄, CoO₂, CeO₂ or TiO₂ powder having a mean particle size of up to 20 μm. The resulting silicone coating is as thin as 5 to 20 μm and has the flame resistance with burning rate of 540 mm/min.

In order to achieve a satisfactory flame resistance performance, more inorganic flame retardants should be employed than the organic halogen-containing retardant which may however cause a pollution problem. However, due to the usual high dosage of inorganic fillers which can ensure an approved flame resistance, it is difficult for the silicone coating containing inorganic filler retardants to achieve low coat weight that is beneficial to various coating applications requiring less material weight and reducing an amount of VOC or other harmful pollutants from the coating. Such a product is for example airbags to which both a high flame resistance and a low coat weight are important.

Therefore, there continues to be a need to figure out an effective method for improving the flame resistance of the silicone rubber composition and preferably further maintaining the coat weight as low as possible.

### SUMMARY OF INVENTION

The inventors of the instant application have surprisingly found that the above-mentioned task can be solved by using a curable silicone composition as defined below. With the inventive composition, an excellent flame resistance (e.g. as specified in FMVSS-302) can be achieved.

Furthermore, the inventive composition may surprisingly result in a low coat weight of no more than 20 gsm, for example 5 to 15 gsm or even below about 10 gsm without impairing the performance of flame resistance. In particular, when coating on the fabrics or polymer substrates like polyamide fibers, polyester fibers, woven and non-woven fabrics, or thermoplastic elastomers and polyurethane sheets, the inventive silicone composition can result in a superior flame resistance of less than 70 mm/min for maximum and average less than 40 mm/min at as low as 10 gsm coat weight.

In a first aspect, the invention relates to a curable silicone composition comprising (A) a polyorganosiloxane polymer containing the siloxane unit represented by the formula (I-1)

R¹ₐZ_{b}SiO_{[4-(a+b)]/2} (I-1)

in which

R¹ is independently selected from the group consisting of hydroxyl, alkoxy, alkenyl, and alkynyl groups,

Z may be the same or different and represent a monovalent hydrocarbon radical having from 1 to 30, preferably from 1 to 12 carbon atoms, preferably selected from alkyl and aryl groups,

a is 1, 2 or 3, b is 0, 1 or 2 and the sum of a+b is 1, 2 or 3;

(B) a cross-linking organosilicon compound having at least 2 silicon-bonded reactive groups;

(C) a catalyst capable of promoting the reaction between component (A) and component (B); and

(D) from 0.001 to 20%, preferably from 0.01 to 16%, more preferably from 0.05 to 12% of a bentonite, based on the total weight of the other components in the composition; wherein the bentonite is treated with a treatment agent containing at least a quaternary ammonium salt.

In a second aspect, the invention relates to use of a bentonite for improving the flame resistance of a curable silicone composition, characterized in that the bentonite is treated with a treatment agent containing a quaternary ammonium salt and is added in an amount of from 0.001 to 20%, preferably from 0.01 to 16%, more preferably from 0.05 to 12%, based on the total weight of the other components in the composition.

In a third aspect, the invention relates to a method of improving the flame resistance of a curable silicone composition, comprising adding into the composition the bentonite, which is treated with a treatment agent containing a quaternary ammonium salt, in an amount of from 0.001 to 20%, preferably from 0.01 to 16%, more preferably from 0.05 to 12%, based on the total weight of the other components in the composition

In a fourth aspect, the invention relates to a product obtained from the curable silicone composition as described above.

### EMBODIMENTS OF INVENTION

Curable Silicone Composition

In the context of the instant description, the terms “curable silicone composition”, “silicone rubber composition”, “liquid silicone rubber” and “silicone coating composition” are synonymous and may be used interchangeably. In the automotive industry, airbags are usually produced by coating such a composition on the fabrics.

The skilled person is aware that the so-called curable silicone composition should be substantially consisting of or comprise the organosilicon compounds, polymer or resin as the main constituent of the polymer matrix. In one advantageous embodiment, the polymer matrix of the curable silicone composition contains at least 50 wt %, preferably at least 65 wt %, more preferably at least 80 wt %, most preferably 90 wt % or 95 wt % or even 100 wt % of the total amount of components (A) and (B).

Component (A)

Component (A) is a polyorganosiloxane polymer containing the siloxane unit represented by formula (I-1)

R¹ₐZ_{b}SiO_{[4-(a+b)]/2} (I-1)

in which

R¹ is independently selected from the group consisting of hydroxyl, alkoxy, alkenyl, and alkynyl groups,

Z may be identical or different and represent a monovalent non-reactive hydrocarbon radical having from 1 to 30, preferably from 1 to 12 carbon atoms, preferably selected from alkyl and aryl groups,

a is 1, 2 or 3, b is 0, 1 or 2 and the sum of a+b is 1, 2 or 3.

Furthermore, the polyorganosiloxane polymer contains optionally at least one siloxane unit having the following formula (I-2):

$${Z}_{c}^{1} {SiO}_{\frac{4 - c}{2}} \qquad \text{(I-2)}$$

in which:
c=0, 1, 2 or 3,
Z¹ may be identical or different and represent a monovalent non-reactive hydrocarbon radical having from 1 to 30, preferably from 1 to 12 carbon atoms, preferably selected from alkyl and aryl groups,

Advantageously, the polyorganosiloxane polymer may substantially consist of the siloxane units of formulae (I-1) and (I-2). It may have a viscosity of at least 50 mPa·s and preferably less than 200,000 mPa·s. In the present disclosure, all viscosity data are concerned with dynamic viscosity values and can be measured, for example, in a known manner at 20° C. using a Brookfield instrument, unless otherwise specified.

The polyorganosiloxane polymer may be of a linear, branched or cyclic structure. The skilled persons understand that in case of linear or branched structure the polyorganosiloxane polymer may be terminated by group —R′ or —SiR′₃ wherein R′, independently from each other, denotes hydroxyl or hydrocarbonyl group such as alkyl, alkoxy, alkenyl, alkynyl or aryl.

In context of the present disclosure, alkyl and alkoxy groups may advantageously have 1 to 18, more preferably 1 to 12, most preferably 1 to 8 carbon atoms and thus include for example methyl, ethyl, propyl, methoxy and ethoxy groups. Alkenyl and alkynyl groups may preferably have 2 to 12, more preferably 2 to 8 carbon atoms and thus include for example vinyl, propenyl and ethynyl groups. Aryl group may have preferably 6 to 20, more preferably 6 to 12 carbon atoms and thus include for example phenyl, tolyl, xylyl or naphthyl group.

In one exemplary embodiment, Z or Z¹ is selected from C₁-C₈ alkyl group, and/or C₆-C₂₀ aryl groups.

Examples of the siloxane units of formula (I-1) may include vinyl dimethylsiloxy, vinylphenylmethylsiloxy, vinyl methylsiloxy and vinyl siloxane units.

The examples of the siloxane unit of formula (I-2) are SiO_{4/2} unit, dimethyl siloxy, methyl phenyl siloxy, diphenyl siloxy, methyl siloxy and phenyl siloxy group.

Examples of the polyorganosiloxane polymer may include linear or cyclic compounds such as dimethylpolysiloxane (including dimethylvinylsilyl end group), (methylvinyl) (dimethyl) polysiloxane copolymers (including trimethylsilyl end group), (methylvinyl) (dimethyl) polysiloxane copolymers (including dimethylvinylsilyl end group) and cyclic methyl vinyl polysiloxane.

In one preferable embodiment of component (A), the polyorganosiloxane polymer may include alkenyl polysiloxane resin A′ comprising or consisting of:

at least two different siloxane units selected from the group consisting of siloxane units M of formula R₃SiO_{1/2}, siloxane units D of formula R₂SiO_{2/2}, siloxane units T of formula RSiO_{3/2} and siloxane units Q of formula SiO₄/2, wherein R represents a monovalent hydrocarbon group having from 1 to 20 carbon atoms, with the proviso that at least one of these siloxane units is the siloxane unit T or Q and at least one of the siloxane units M, D and T comprises an alkenyl group.

Advantageously, the polysiloxane resin A′ has a weight average molecular weight in the range of from 200 to 100,000, preferably from 200 to 50,000, more preferably from 500 to 30,000. Here, the weight average molecular weight can be obtained by gel permeation chromatography and using polystyrene as a standard.

Advantageously, if all or substantially all of the alkenyl groups in the polyorganosiloxane polymer or preferably polysiloxane resin A′ are bonded to the siloxane unit M (M^{Vi} unit) or siloxane unit D (D^{Vi} unit), the silicone compositions of the present disclosure are able to cure at room temperature or higher temperatures more rapidly than those having the alkenyl groups to be bonded in other manners.

Above mentioned are merely some examples of the polysiloxane resin A′. It will be apparent to those skilled in the art that other resins constituted by the units M, T, D and Q are also suitable for use as the polysiloxane resin.

In one embodiment, the amount of the polysiloxane resin A′ may range from 0 to 50% by weight, preferably 1 to 40% by weight and more preferably 5 to 35% by weight, based on the total weight of the composition.

In the context of the present disclosure, when referring to a composition or component, in particular a polysiloxane resin or component (A) and (B), the term “(substantially) . . . consisting of/comprising” means that the related composition or component comprises more than 50% by weight, for example, at least 60% by weight, at least 70% by weight, or at least 80% by weight, or even 100% by weight of the listed substances, based on the total weight of the related composition or component.

Component (B)

Component (B) is a cross-linking organosilicon compound having at least 2 or even 3 silicon-bonded reactive groups, per molecule, which is capable of reacting with Component (A) described above, in particular respectively with the reactive groups R¹ like alkenyl or hydroxyl group of component (A) based on the cure mechanism as is well known to the skilled person. The cross-linking organosilicon compound may be monomer, oligomer or polymer. In one embodiment, they preferably have a viscosity of not greater than 1000 mPa-s at 25° C. and more preferably 2 to 500 mPa-s at 25° C.

In one possible embodiment, suitable cross-linking organosilicon compounds are multi-functional silane compounds that may initiate a condensation reaction and can be represented generally by the formula R₄₋ₙSi—Yₙ, wherein n is 3 or 4, R is a non-reactive hydrocarbonyl group like alkyl or aryl and Y is a hydrolyzable functional group. Depending on various crosslinking mechanism with polysiloxane polymer, the group Y may contain carbonyloxy (—OCO—), oxime (—ON═C<), ether (—O—), amine, amide (>N—CO—), alkenyloxy and/or aminoxyl (—O—N<) groups. Accordingly, the group Y may be selected from the group consisting of alkoxy (—OR′″), —OCOR′″, —ON═CR′″₂, —NHR′″, —NR′″COR′″, —O—C(R′″)═CH₂ and —ONR′″₂, wherein R′″ denotes a non-reactive hydrocarbonyl group such as alkyl or aryl having 1 to 30 carbon atoms, preferably methyl, ethyl, propyl. The preparation methods of these cross-linking organosilicon compounds are well known or easily available to the skilled person.

In another preferable embodiment, the cross-linking organosilicon compound is a monomer, a homopolymer, a copolymer or mixtures thereof which comprises at least one unit of the general formula R⁴_{a′}R⁵_{b′}SiO_{4-a′-b′/2} wherein R⁴ is selected from the group consisting of alkyl, and aryl groups having from 1 to about 18 carbon atoms, R⁵ is a reactive group selected from the group consisting of hydrogen, hydroxy, and alkoxy, and a′ has a value of 0 or 1, b′ has a value of from 2 to 3, the sum of a′+b′ is 2 or 3.

As discussed above, the reactive groups bonded to Si atoms in component (B) are selected depending on the selection of the functional groups of component (A) and various curing mechanism. For example, in case of addition curing reaction that is preferable, the cross-linking organosilicon compound may comprise or consist of a hydrogen-containing polysiloxane containing at least two, preferably three or more Si—H groups bonded to the same or different silicon atom(s) per molecule so as to react and crosslink with the alkenyl group in component (A) according to the hydrosilylation mechanism, thereby forming a cured product.

In one preferable embodiment of the addition curing reaction, the hydrogen-containing polysiloxane comprises:

(i) at least two siloxane units and preferably at least three siloxane units having the following formula:

$${H}_{d} {Z}_{e}^{3} {SiO}_{\frac{4 - ( d + e )}{2}} \qquad \text{(II-1)}$$

in which:
d=1 or 2 or 3, e=0, 1 or 2 and d+e=1, 2 or 3,
Z³ may be identical or different and represent a monovalent hydrocarbon radical having from 1 to 30, preferably from 1 to 12 carbon atoms, preferably selected from C₁-C₈ alkyl and C₆-C₂₀ aryl groups, and

(ii) optionally at least one siloxane unit having the following formula:

$${Z}_{f}^{3} {SiO}_{\frac{4 - f}{2}} \qquad \text{(II-2)}$$

in which:
f=0, 1, 2 or 3,
Z³ may be identical or different and have the same meanings as given above.

In a preferred embodiment, Z³ may be selected from the group consisting of methyl, ethyl, propyl, 3,3,3-trifluoropropyl, phenyl, xylyl and tolyl and so on.

The hydrogen-containing polysiloxane has a kinematic viscosity of at least 10 mPa·s and preferably between 20 and 1000 mPa·s.

The hydrogen-containing polysiloxane may be substantially consisting of the units of formula (II-1) and the optional units of formula (II-2). The hydrogen-containing polysiloxane may be of a linear, branched or cyclic structure. Likewise, the skilled person also understands that in case of linear or branched structure the component (B), preferably the hydrogen-containing polysiloxane, may be terminated by group —R″ or —SiR″₃ wherein R″, independently from each other, has the meaning given for groups Z³ or represents H.

Examples of the units of formula (II-1) include H(CH₃)₂SiO_{1/2}, HCH₃SiO_{2/2} and H(C₆H₅)SiO_{2/2}. Examples of the units of formula (II-2) may be the same as those given above for the units of formula (I-2).

Examples of the hydrogen-containing polysiloxane include linear, branched or cyclic compounds such as dimethylpolysiloxane (including hydrogenated dimethylsilyl end group), copolymers having (dimethyl) (hydromethyl) polysiloxane units (including trimethylsilyl end group), copolymers having (dimethyl) (hydromethyl) polysiloxane units (including hydrogenated dimethylsilyl end group), hydrogenated methyl polysiloxane having trimethylsilyl end group and cyclic hydrogenated methyl polysiloxane.

In some cases, the hydrogen-containing polysiloxane may be a mixture of a dimethylpolysiloxane containing hydrogenated dimethylsilyl end group and an organopolysiloxane containing at least three hydrosilyl groups.

When the reactive group such as R¹ of component (A) is a hydroxyl or an alkoxy group, it is preferred that the reactive groups in the cross-linking organosilicon compound are either alkoxy groups or hydroxyl groups respectively, allowing a condensation reaction to take place between two components. When the reactive group of component (A) is hydroxyl or an alkenyl group, the reactive groups in the cross-linking organosilicon compound may be hydrogen atoms, allowing either condensation or addition reaction between two components.

Component B is used in amounts which are conventionally used for making curable liquid silicone rubber compositions. The amounts used will vary depending upon the particular crosslinking mechanism of the chosen reactive groups and the properties desired. In an exemplary embodiment, for a condensation-cured composition, the crosslinking component B is present in an amount of from about 0.1-15 parts by weight per 100 parts by weight of component A.

In order to obtain a high-quality cured product using addition cure, the molar ratio of the total silicon-bonded hydrogen in component B to the silicon-bonded alkenyl groups in component A preferably falls in the range of 1:2 to 15:1. Even more preferably, component B is added at a concentration sufficient to provide a molar ratio of silicon-bonded hydrogen to silicon-bonded alkenyl provided by component A is in the range of about 1:1 to 3:1.

Component (C)

Component (C) is a catalyst capable of catalyzing or promoting the reaction between component (A) and component (B). Depending on types of the crosslinking reaction of the silicone rubber composition, i.e. either condensation or addition reaction, the skilled person selects the specific suitable compounds for component (C).

In one embodiment of the silicone coating composition that is to be cured by condensation reaction, the catalyst may be any of the known condensation catalysts, such as those catalysts based on tin or titanium. Useful organotin compounds are those with the valence of the tin of either +2 or +4. These tin compounds are known in the art to promote the reaction between alkoxy groups substituted on silicon and hydroxyl groups substituted on silicon. Typical tin compounds useful as condensation catalysts include stannous salts of carboxylic acids such as stannous stearate, stannous oleate, stannous naphthanate, stannous hexoate, stannous succinate, stannous caprylate, and stannous octoate; and stannic salts of carboxylic acids, such as dibutyltindilaurate, dibutyltindiacetate, dibutyltindioctoate, dibutyltindiformate, and dibutyltindineodecanoate, as well as partially hydrolyzed products of the above. For the purposes of the present invention, dibutyltindilaurate, dimethyltindineodecanoate, and stannous octoate are preferred catalysts.

In one embodiment of the silicone coating composition that is to be cured by addition reaction, suitable addition catalysts include platinum group metal-based catalyst such as rhodium, ruthenium, palladium, osmium, iridium or platinum containing catalysts. Platinum-based catalysts are particularly preferred and may take any of the known forms, ranging from platinum deposited onto carriers, for example powdered charcoal, to platinic chloride, salts of platinum, chloroplatinic acids, and encapsulated forms thereof. A preferred form of platinum catalyst is chloroplatinic acid, platinum acetylacetonate, complexes of platinous halides with unsaturated compounds such as ethylene, propylene, organovinylsiloxanes, and styrene; hexamethyldiplatinum, PtCl₂, PtCl₃, PtCl₄, and Pt(CN)₃. Alternatively, the platinum group catalyst is a platinum catalyst. Suitable forms of platinum catalysts include but are not limited to chloroplatinic acid, 1,3-diethenyl-1,1,2,2-tetramethyldisiloxane platinum complex, complexes of platinous halides or chloroplatinic acid with divinyldisiloxane and complexes formed by the reaction of chloroplatinic acid, divinyltetrahmethyldisiloxane and tetramethyldisiloxane. Component (C) is used in an amount sufficient to crosslink the present silicone rubber composition within a desired time, which can be typically determined by routine experimentation. Generally, condensation catalysts may be added at a level of about 0.01 to 10 parts by weight, preferably 0.1 to 5 parts by weight, for each 100 parts by weight of Component (A). Furthermore, the effective amount of addition catalysts such as platinum-based catalyst may be for example from about 0.1 to 1000 parts by weight of metal (e.g. platinum) per million parts, preferably from 2 to 100 ppm, more preferably 5 to 50 ppm, based on the total weight of the composition.

Component (D)

Component (D) is a bentonite that is treated by a treatment agent containing at least a quaternary ammonium salt. Preferably, it is a nanoscale platelet filler bentonite compound. The nanoscale platelet filler may be in the form of a nanocomposite, which is a dispersion of a filler like bentonite material in a polymer or resin. The bentonite material is surface treated with the treatment agent containing a quaternary ammonium salt that will be retained on their surface. The quaternary ammonium salt contains carbon chain of from 6 to 30, preferably from 10 to 18 carbon atoms.

In one embodiment, the suitable quaternary ammonium salt includes alkyl quaternary ammonium salt which contains an alkyl carbon chain from C₆-C₃₀, preferable C₁₀-C₁₃. In addition to the quaternary ammonium salt, the treatment agent may further comprise at least one coadjuvant selected from functional organosilane compound containing vinyl, amino, alkyl, methacryloxy and epoxy group; organic titanate coupling agent; octadecanoic acid; and other compounds containing functional groups that may result in or facilitate the same treated effects. Preferably, the treatment agent contains or consists of at least 50 wt. %, more preferably at least 60 wt. % or at least 70 wt. % or 90 wt. % of quaternary ammonium salt and optionally said coadjuvant. In one advantageous embodiment, the bentonite is treated with quaternary ammonium salt in an amount of more than 15%, preferably more than 30%, calculated by the ammonium ions and based on the total weight of the treated bentonite.

Furthermore, preferably the bentonite material contains no halogen. Commercial products of such a bentonite compound include for example Garamite® 1958 or Garamite® 1210. Also preferably, no halogen or halogen-containing compound is contained in the composition.

It is surprisingly found that the bentonite compound surface treated at least with a quaternary ammonium salt is well compatible with the silicone matrix and brings out superior flame resistance performance, meanwhile keeping the coat weight of the silicone composition as low as less than 10 gsm.

In one embodiment, the treated bentonite compound has preferably a particle size D50=1-50 μm, such as 5-30 μm.

The bentonite compound is added in an amount of from 0.001 to 20%, preferably from 0.01 to 16%, and more preferably from 0.05 to 12%, such as from 0.1% or 0.15% to about 11%, based on the total weight of the other components in the composition. It has been found that the flame resistance will be surprisingly enhanced when using even only a little amount of the bentonite compound. However, the low coat weight property or even processability may be impaired when the amount exceeds 20%.

Other Optional Components

In addition to the above-discussed components (A) to (D), the curable silicone composition according to the invention can optionally comprise further components so as to adjust the overall properties of the composition as desired.

One example of such additional components is an adhesive promotor. In one embodiment of the disclosure, the adhesive promoter may be one or more selected from epoxy silane, alkoxy silane, acyloxy silane, aryloxy silane or oligomers thereof. They include, but are not limited to, 3-glycidoxypropyl trimethoxy silane, octyltriethoxysilane, vinyltriethoxysilane, vinyltrimethoxysilane, gamma-methacryloxy-propyltrimethoxysilane, beta-(3,4-epoxycyclohexyl)-ethyltrimethoxysilane beta-(3,4-epoxycyclohexyl)-ethyltriethoxysilane and bis (trimethoxysilyl propyl) fumarate, alkoxy or aryloxy silicones such as trimethoxysilyl functional groups modified silicones. Furthermore, they also include silanols, oligosiloxanes containing one or more alkoxy silyl functional group, polysiloxanes containing alkoxysilyl functional group, one or more oligomeric siloxanes containing hydroxyl functional groups, polysiloxanes containing one or more aryloxy silyl functional group, cyclosiloxanes containing one or more alkoxy silyl functional group, cyclosiloxanes containing one or more hydroxyl groups, tetra-alkoxy silanes, vinyltrimethoxysilane, and mixtures thereof, and combinations thereof.

The amount of the adhesive promoter may be from 0.01 to 5 parts, preferably 1 to 3 parts by weight per 100 parts by weight of component (A).

Examples of the component that may be additionally contained in the composition include pigment, colorant or other fillers like silica, calcium carbonate, quartz, Wollastonite, cerium oxides, Al(OH)₃, Fe₂O₃, Al₂O₃, mica, Talc, MgO, Mg(OH)₃, TiO₂. But, these fillers are preferably used in an amount of less than 30% by weight, preferably less than 10% by weight or more preferably less than 5% or even 0%, since high amount of these fillers will not contribute to any further improvement of flame resistance but greatly impair the low coat weight performance. In a preferable embodiment, the composition contains silica and/or calcium carbonate preferably in an amount of 1-25% by weight, more preferable 5-20% by weight, based on the total weight of the composition.

As for the method of improving the flame resistance of a curable silicone composition, the inventive process comprises the step of adding into the composition a bentonite, which is treated with a treatment agent containing at least a quaternary ammonium salt, in an amount of from 0.001 to 20%, preferably from 0.01 to 16%, more preferably from 0.05 to 12% of a bentonite, based on the total weight of the other components in the composition.

The order of mixing individual components of the inventive silicone composition is not strictly restricted. In one embodiment according to the inventive method, a premix of component (A), component (B) and optionally component (C) may be initially formed under sufficient stirring at e.g. ambient temperature, and then the component (D) treated bentonite is added into the premix.

After the preparation of the inventive silicone composition, the curing reaction is initiated under different reaction conditions depending on the crosslinking mechanism.

In the last aspect of this disclosure, the invention relates to a product obtained from the curable silicone composition as described above. In an exemplary embodiment, the product is obtainable by coating the inventive curable silicone composition on the substrate with any conventional manner like dip coating, roll coating and brush coating etc., and then curing the composition under the suitable conditions known to the skilled person in the art, with or without heating. In an illustrative embodiment, the curing may be carried out at the temperature between 120 to 220° C. for not more than 10 min or preferably 5 min, for example at the temperature from 150 to 180° C. for 45 seconds to 120 seconds.

In a preferable embodiment, the suitable substrate on which the inventive curable silicone composition is coated includes for example fabrics, a polymeric film, thermoplastic elastomer, metal, glass like fiberglass or ceramic materials, preferably fabrics including a woven fabric or a nonwoven fabric or a polymeric film or sheet, such as polypropylene, polyethylene, polyamides, poly(ethylene) terephthalate, polyurethane, polyester, and compositions or mixtures thereof. In a preferable embodiment, such a product may be an airbag.

### EXAMPLES

First Part on Coated Fabric Flame Test

Testing Sample Preparation:

Knife coating the silicone liquid coating composition on the fabrics and then curing at 160° C. for 2 min

Fabric: Polyamide 66, 470 dtex, 51*51 (cm)

Measure of the coat weight: weighing the blank before coating (W1), weighing the coated fabric after curing (W2) and measuring the coated area S. Calculating the weight according to following equation:

CW=(W2−W1)/S,

unit: gram per square meter

Test Equipment:

Testing standard: FMVSS-302

Test condition: without wire, uncoated side towards fire;

Raw Materials:

| | CAS No. | Description |
|---|---|---|
| Component A1 | | mixture of MD^{Vi}Q resin and vinyl |
| | | terminal-polydimethylsiloxane oil with |
| | | a ratio of about 1:3.35 |
| Component B1 | | methyl and hydrogen terminated |
| | | polymethylhydrogensiloxane with SiH |
| | | content of 0.69 mol/100 g |
| Component C1 | | Platinum(0)-1,3-divinyl-1,1,3,3-tetra- |
| | | methyldisiloxane (Pt content: 10 wt %) |
| Garamite 1958 | | Bentonite treated with 20 wt. % of alkyl |
| | | quaternary ammonium salt |
| CP-250 | | Bentonite treated with 45 wt. % of alkyl |
| | | quaternary ammonium salt |
| CP-27 | | Bentonite treated with 36 wt. % of alkyl |
| | | quaternary ammonium salt |
| Precipitated | 471-34-1 | |
| Calcium | | |
| Carbonate | | |
| Non treated | 1302-78-9 | |
| bentonite | | |
| Wollastonite | | Untreated wollastonite, 10 μm |
| Aluminium | | Al(OH)₃ without treatment, 10 μm |
| hydroxide | | |
| Ferric oxide | | Fe₂O₃ |
| Component A2; | | mixture of fumed silica and vinyl |
| | | terminal-polydimethylsiloxane oil with |
| | | a ratio of about 1:3.98 |
| Component B2 | | Methyl terminated polymethyl |
| | | hydrogensiloxane with 0.415 mol/100 |
| | | g SiH content |
| Component B3 | | Hydrogen terminated polymethyl |
| | | siloxane with SiH content of 0.19 |
| | | mol/100 g |
| Component A3 | | mixture of precipitated silica and |
| | | hydroxygen-terminal-polydimethyl- |
| | | siloxane oil with a ratio of about |
| | | 1:4.00 |
| Component B4 | 68412-37-3 | Hydrolyzed tetraethylorthosilicate |
| Component C2 | | Dibutyltin dilaurate |
| Quatz | 14808-60-7 | non-treated |

### Example 1 (Comparative Example 1)

75.53 part Component A1 with 14.655 part precipitated calcium carbonate, 5.45 part component B1 and 0.02 part 1-ethynyl-1-cyclohexanol was loaded and mixed in 100 g speed mixer cups under 2000 rpm for 30 sec. Thereafter the promoter 0.75 part Vinyltrimethoxysilane and 1.45 part (3-Glycidyloxypropyl)trimethoxysilane was added into speed mixer and mixed under 2000 rpm for 30 sec, followed by adding 2.1 part Titanium tetrabutanolate and 0.03 part Component C1 and further mixing under 2000 rpm for 30 sec. The prepared mixture of example 1 was tested with regard to the flame resistance and used as a premix for examples 2-6.

### Examples 2-8

Samples of Examples 2-8 were prepared by adding respective fillers i.e. Garamite 1958, CP-250, CP-27, Wollastonite, aluminum hydroxide and ferric oxide in respective amounts as specified in table 1 into the premix according to Example 1 and then mixing in speed mixer under 2000 rpm for 30 sec. The compositions and test results are shown in table 1.

Comparison Formula (Comp.)

75.53 part Component A1 with 14.655 part Non-treated bentonite, 5.45 part component B1 and 0.02 part 1-ethynyl-1-cyclohexanol was loaded and mixed in 100 g speed mixer cups under 2000 rpm for 30 sec. Thereafter the promoter 0.75 part Vinyltrimethoxysilane and 1.45 part (3-Glycidyloxypropyl)trimethoxysilane was added into speed mixer and mixed under 2000 rpm for 30 sec, followed by adding 2.1 part Titanium tetrabutanolate and 0.03 part Component C1 and further mixing under 2000 rpm for 30 sec.

TABLE 1

| Example | 1 | 2 | 3 | 4 | 5 | 6 | 7 | 8 | Comp. |
|---|---|---|---|---|---|---|---|---|---|
| Premix (g) | 100 | 100 | 100 | 100 | 100 | 100 | 100 | 100 | |
| Garamite 1958 (g) | 0 | 2.04 | 3.09 | | | | | | |
| CP-250 (g) | | | | | | | 3 | | |
| CP-27 (g) | | | | | | | | 3 | |
| Wollastonite (g) | | | | 40 | | | | | |
| Al(OH)₃ (g) | | | | | 40 | 40 | | | |
| Fe₂O₃ (g) | | | | | | 4.5 | | | |
| Coat weight (gsm) | 10 | 10 | 10 | 15 | 15 | 17 | 10 | 10 | 10 |
| Average Burn | 94.6 | 60.2 | 34.2 | 48.3 | 71.2 | 50 | 31 | 23 | 167 |
| rate(mm/min) | | | | | | | | | |

Test Results:

Example 4-6 can't achieve a low coat weight 10 gsm under same coating condition. Above trials showed that average burn rate less than 40 mm/min can be achieved with only 3% of bentonite, and the low coat weight of about 10 gsm can be achieved by knife coating. As for other fillers, coat weight fails to arrive at a level of less than 15 gsm and even with much higher dosage, it is still hard to achieve average burn rate less than 40 mm/min.

Testing Sample Preparation:

Knife coating the silicone liquid coating composition on the fabrics and then curing at 160° C. for 2 min

Fabric: Polyamide 66, 470 dtex, 46*46 (cm)

Measure of the coat weight: weighing the blank before coating (W1), weighing the coated fabric after curing (W2) and measuring the coated area S. Calculating the weight according to following equation:

CW=(W2−W1)/S,

unit: gram per square meter

Test Equipment:

Testing standard: FMVSS-302

Test condition: without wire, uncoated side towards fire;

TABLE 2

| Example | 1 | 9 | 10 | 12 |
|---|---|---|---|---|
| Premix (g) | 100 | 100 | 100 | 100 |
| Garamite 1958 (g) | 0 | 0.25 | 10 | 0.25 |
| Al(OH)₃ (g) | | | | 40 |
| Coat weight (gsm) | 10 | 10 | 10 | 12 |
| Average Burn | 131 | 79 | 88 | 86 |
| rate(mm/min) | | | | |
| Minimum burn | 86 | 58 | 41 | 54 |
| rate(mm/min) | | | | |

Test Results:

Examples 9, 10, 12 were also prepared based on the premix as described above with adding various fillers as listed in table 2. They all showed better flame resistance performance on fabrics compared with example 1, and 0.25% dosage of treated Bentonite can improve the performance 40%.

Second Part on Cured Silicone Elastomer Flame Test

Testing Sample Preparation:

Degassing for 2 to 10 min, pouring mixed liquid silicone into the 2 mm thickness Teflon treated metal mold and then curing in the oven at 150° C. for 30 min. Cutting the cured slab into 2 cm width and 15 cm length pieces and placing them under 23±2° C., 50±5% RH for 48 hours.

Test condition: Each specimen is supported such that its lower end is 10 mm above Bunsen burner tube. Then the specimen is suspended. A blue 20 mm high flame is applied to the center of the lower edge of the specimen for 10 seconds and then removed. As for each formula, five specimens are tested and the individual extinguishing time for each specimen is recorded. t1 is reported as an average of five extinguishing times.

### Example 13 (Comparative Example 2)

95.27 part component A2, 3.12 part component B2, 1.45 part component B3 and 0.155 part Methylvinylcyclosiloxanes was loaded and mixed in 100 g speed mixer cups under 2000 rpm for 30 sec, followed by adding 0.0182 part component C₁ and further mixing under 2000 rpm for 30 sec. The prepared mixture of Example 13 was tested with regard to the flame resistance and used as a premix for Examples 14-15.

### Examples 14-15

Samples of Examples 14-15 were prepared by adding Garamite 1958 in various amounts as specified in table 2 into the premix according to Example 13 and then mixing in speed mixer under 2000 rpm for 30 sec. The compositions and test results were shown in table 3.

TABLE 3

| Example | 13 | 14 | 15 |
|---|---|---|---|
| Premix (g) | 100 | 100 | 100 |
| Garamite 1958 (g) | 0 | 0.25 | 3 |
| SUM (g) | 100 | 100.25 | 103 |
| t1 (s) | 121 | 51 | 30 |

Test Results:

Above trials showed that with only 3 parts of bentonite an average t1 less than 50 sec can be achieved.

Third Part on Cured Silicone Elastomer Flame Test

Testing Sample Preparation:

Degassing for 2 to 10 min, pouring mixed liquid silicone into the 2 mm thickness Teflon treated metal mold at room temperature and then curing for 24 hours. Then cutting the cured slab into 2 cm width and 15 cm length pieces and placing them under 23±2° C., 50±5% RH for 48 hours. Test condition: Each specimen is supported such that its lower end is 10 mm above Bunsen burner tube. The specimen is suspended. Then a blue 20 mm high flame is applied to the center of the lower edge of the specimen for 10 seconds and removed. Record the burn time, the burn distance.

### Example 16 (Comparative Example 3)

58.37 part component A3 with 24.991 part component B4, 12.65 part untreated quartz filler and 0.285 part hydroxygen terminated polydimethylsiloxane oil with 45 mpa·s viscosity was loaded and mixed in 100 g speed mixer cup under 2000 rpm for 30 sec, followed by adding 3.58 part component C₂. The prepared mixture of Example 16 was tested with regard to the flame resistance and used as a premix for Example 17.

### Example 17

Sample of Example 17 was prepared by adding 100 part premix of Example 16 with 3 part Garamite 1958 in 100 g speed mixer cups and then mixing in speed mixer under 2000 rpm for 30 sec. The composition and test results were shown in table 3.

TABLE 4

| Example | 16 | 17 |
|---|---|---|
| Premix (g) | 100 | 100 |
| Garamite 1958 (g) | 0 | 3 |
| Burn time (s) | 180 | 360 |
| Burn distance (mm) | 15 | 7 |

Test Results:

Only 3 parts of treated bentonite can half the burn distance.

1. A curable silicone composition comprising:
(A) a polyorganosiloxane polymer containing the siloxane unit represented by the formula (I-1)
R¹ₐZ_{b}SiO_{[4-(a+b)]/2} (I-1)
in which
is independently selected from the group consisting of hydroxyl, alkoxy, alkenyl, and alkynyl groups,
Z may be the same or different and represent a monovalent non-reactive hydrocarbon radical having from 1 to 30, optionally from 1 to 12 carbon atoms, optionally selected from alkyl and aryl groups,
a is 1, 2 or 3, b is 0, 1 or 2 and the sum of a+b is 1, 2 or 3;
(B) a cross-linking organosilicon compound having at least 2 silicon-bonded reactive groups;
(C) a catalyst capable of promoting the reaction between component (A) and component (B); and
(D) from 0.001 to 20%, optionally from 0.01 to 16%, optionally from 0.05 to 12% of a bentonite, based on the total weight of other components in the composition;
wherein bentonite is treated with a treatment agent comprising at least a quaternary ammonium salt.

2. The curable silicone composition according to claim 1, wherein the bentonite is treated with quaternary ammonium salt in an amount of more than 15%, optionally more than 30%, calculated by the ammonium ions and based on the total weight of the treated bentonite.

3. The curable silicone composition according to claim 1, wherein the polyorganosiloxane polymer comprising at least one siloxane unit of formula (I-2):
$${Z}_{c}^{1} {SiO}_{\frac{4 - c}{2}} . \qquad \text{(I-2)}$$
in which:
c=0, 1, 2 or 3,
Z¹ may be identical or different and represent a monovalent non-reactive hydrocarbon radical having from 1 to 30, optionally from 1 to 12 carbon atoms, optionally selected from alkyl and aryl groups,

4. The curable silicone composition according to claim 1, wherein Z or Z¹ is selected from C₁-C₈ alkyl group and/or C₆-C₂₀ aryl groups.

5. The curable silicone composition according to claim 1, wherein the polyorganosiloxane polymer comprises alkenyl polysiloxane resin A′ that comprises at least two different siloxane units selected from the group consisting of siloxane units M of formula R³SiO_{1/2}, siloxane units D of formula R²SiO_{2/2}, siloxane units T of formula RSiO_{3/2} and siloxane units Q of formula SiO_{4/2}, wherein R represents a monovalent hydrocarbon group having from 1 to 20 carbon atoms, and with the proviso that at least one of these siloxane units is the siloxane unit T or Q and at least one of the siloxane units M, D and T comprises an alkenyl group.

6. The curable silicone composition according to claim 1, wherein that the cross-linking organosilicon compound is a monomer, a homopolymer, a copolymer or mixtures thereof which comprises at least one unit of formula R⁴_{a′}R⁵_{b′}SiO_{4-a′-b′/2} wherein R⁴ is selected from the group consisting of alkyl, aryl, and halogenated alkyl groups having from 1 to about 18 carbon atoms, R⁵ is a reactive group selected from the group consisting of hydrogen, hydroxy, and alkoxy, a′ has a value of 0 or 1, b′ has a value of from 2 to 3, and the sum of a′+b′ is 2 or 3.

7. The curable silicone composition according to claim 1, wherein the cross-linking organosilicon compound comprises a hydrogen-containing polysiloxane containing at least two, optionally three or more Si—H groups bonded to the same or different silicon atom(s) per molecule.

8. The curable silicone composition according to claim 7, wherein the hydrogen-containing polysiloxane comprises:
(i) at least two siloxyl units and optionally at least three siloxyl units of formula:
$${H}_{d} {Z}_{e}^{3} {SiO}_{\frac{4 - ( d + e )}{2}} \qquad \text{(II-1)}$$
in which:
d=1 or 2 or 3, e=0, 1 or 2 and d+e=1, 2 or 3,
Z³ may be identical or different and represent a monovalent hydrocarbon radical having from 1 to 30, optionally from 1 to 12 carbon atoms, optionally selected from C₁-C₈ alkyl and C₆-C₂₀ aryl groups, and
(ii) optionally at least one siloxane unit of formula:
$${Z}_{f}^{3} {SiO}_{\frac{4 - f}{2}} \qquad \text{(II-2)}$$
in which:
f=0, 1, 2 or 3,
Z³ may be identical or different.

9. The curable silicone composition according to claim 1, the quaternary ammonium salt comprises a carbon chain of from 6 to 30, optionally from 10 to 18 carbon atoms.

10. The curable silicone composition according to claim 1, wherein said quaternary ammonium salt includes an alkyl quaternary ammonium salt that comprises an alkyl carbon chain from C₆-C₃₀, optionally preferable C₁₀-C₁₈.

11. The curable silicone composition according to claim 1, wherein the treatment agent further comprises at least one selected from functional organosilane compound containing vinyl, amino, alkyl, methacryloxy and epoxy group; organic titanate coupling agent; octadecanoic acid; and other compounds comprising one or more functional groups.

12. A curable silicone composition according to claim 1, wherein the composition further comprises an adhesive promoter.

13. The curable silicone composition according to claim 12, wherein the adhesive promoter is an organic silicone compound having at least 1 alkenyl group and at least one epoxy and/or trialkoxysilyl group bond to the same or different silicon atom.

14. The curable silicone composition according to claim 1, wherein the total amount of components (A) and (B) is more than 50%, optionally more than 65%, optionally more than 80% and optionally more than 90% by weight, based on a polymer matrix of the composition.

15. The curable silicone composition according to claim 1, wherein the composition comprises silica and/or calcium carbonate optionally in an amount of 1-25% by weight, optionally 5-20% by weight, based on the total weight of the composition.

16. A product comprising a bentonite for improving the flame resistance of a curable silicone composition according to claim 1, wherein the bentonite has been treated with a treatment agent comprising a quaternary ammonium salt and is added in an amount of from 0.001 to 20%, optionally from 0.01 to 16%, optionally from 0.05 to 12%, based on the total weight of other components in the composition.

17. A method of improving flame resistance of a curable silicone composition as defined in claim 1, comprising adding into the composition bentonite, which is treated with a treatment agent comprising a quaternary ammonium salt, in an amount of from 0.001 to 20%, optionally from 0.01 to 16%, optionally from 0.05 to 12%, based on the total weight of other components in the composition

18. A product obtained by curing the curable silicone composition as defined in claim 1 optionally comprising an airbag.
